(19) United States
(12) Patent Application Publication
(10) Pub. No.: US 2014/0092125 A1
(43) Pub. Date: Apr. 3, 2014

(54) Filtering Documents Based on Device Orientation

(71) Applicant: APPLE INC., Cupertino, CA (US)

(72) Inventors: Rachel Patricia Max, San Francisco, CA (US); Behkish J. Manzari, San Francisco, CA (US); G. Garrett Groszko, Oakland, CA (US); Eric Hanson, Emeryville, CA (US)

(73) Assignee: APPLE INC., Cupertino, CA (US)

(21) Appl. No.: 13/630,260

(22) Filed: Sep. 28, 2012

(51) Int. Cl. G09G 5/34

(52) U.S. Cl. 345/629; 345/655

(57) ABSTRACT

In some implementations, document templates can be presented on a mobile device for selection by a user when the user is creating a document. In some implementations, document templates can be filtered based on the orientation of the mobile device. In some implementations, images (e.g., photographs, pictures, drawings, etc.) that match the current orientation of the mobile device are displayed on the mobile device for selection and addition to a document template. In some implementations, animations can be presented while the user is browsing document templates. In some implementations, document templates can be presented on a user interface of the mobile device. As the user scrolls through the document templates, the document templates can appear to move, shake, flutter, rock and/or expand in response to the scrolling movement. In some implementations, a preview of a document template can be displayed in response to a touch gesture.

### TECHNICAL FIELD

The disclosure generally relates to document selection and editing.

### BACKGROUND

Computing devices can be used to create many types of documents. For example, computer software (e.g., word processors) can be used to create greeting cards, posters, fliers, calendars and other documents. Often document templates are provided to give users a starting point when creating a document. The document templates can provide pre-generated themes that have different designs, appearances, and/or images for different occasions such as birthdays, holidays or other events. The user can modify or customize the document templates to provide details for the occasion. For example, the user can customize a greeting card to add a person's name or a personalized greeting.

### SUMMARY

In some implementations, document templates can be presented on a mobile device for selection by a user when the user is creating a document. In some implementations, document templates can be filtered based on the orientation of the mobile device. In some implementations, document templates having an orientation (e.g., landscape orientation, portrait orientation) that match the current orientation of the mobile device are displayed on the mobile device while document templates having an orientation that does not match the current orientation of the mobile device can be filtered out or hidden. In some implementations, images can be filtered based on the orientation of the mobile device. In some implementations, images (e.g., photographs, pictures, drawings, etc.) that match the current orientation of the mobile device are displayed on the mobile device for selection and addition to a document template.

In some implementations, animations can be presented while the user is browsing document templates. In some implementations, document templates can be presented on a user interface of the mobile device. As the user scrolls through the document templates, the document templates can appear to move, shake, flutter, rock and/or expand in response to the scrolling movement. In some implementations, a preview of a document template can be displayed in response to a touch gesture. For example, a de-pinch gesture over a greeting card can cause the card to open thereby displaying the inside of the greeting card.

Particular implementations provide at least the following advantages: The display area of a mobile device can be more fully or more efficiently used by presenting documents based on the orientation of the mobile device. Less display space is wasted and a larger view of a document can be displayed by presenting documents having a particular orientation on a mobile device that is currently in the same orientation. Document templates can be previewed in place without requiring a separate preview display. Animating the document templates in response to movement (e.g., scrolling) provides a more realistic and fun interaction experience.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates a mobile device configured to detect the orientation of the mobile device.

FIG. 2 illustrates document templates having portrait and landscape orientations.

FIG. 3 illustrates a graphical interface for browsing and selecting landscape oriented document templates.

FIG. 4 illustrates a graphical interface for scrolling document template categories.

FIG. 5 illustrates a graphical interface for previewing and selecting a document template in landscape orientation.

FIG. 6 illustrates an animation for transitioning from the document template selection interface of FIG. 5 to the document template editing interface of FIG. 7.

FIG. 7 illustrates an example of a landscape oriented document editing interface.

FIG. 8 illustrates an example graphical interface for browsing and selecting portrait oriented document templates.

FIG. 9 illustrates a graphical interface for previewing and selecting a document template in portrait orientation.

FIG. 10 illustrates an example of a portrait oriented document editing interface.

FIG. 11 is flow diagram of an example process for browsing and selecting document templates.

FIG. 12 is a block diagram of an exemplary system architecture implementing the features and processes of FIGS. 1-11.

Like reference symbols in the various drawings indicate like elements.

### DETAILED DESCRIPTION

### Overview

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

### Device Orientation

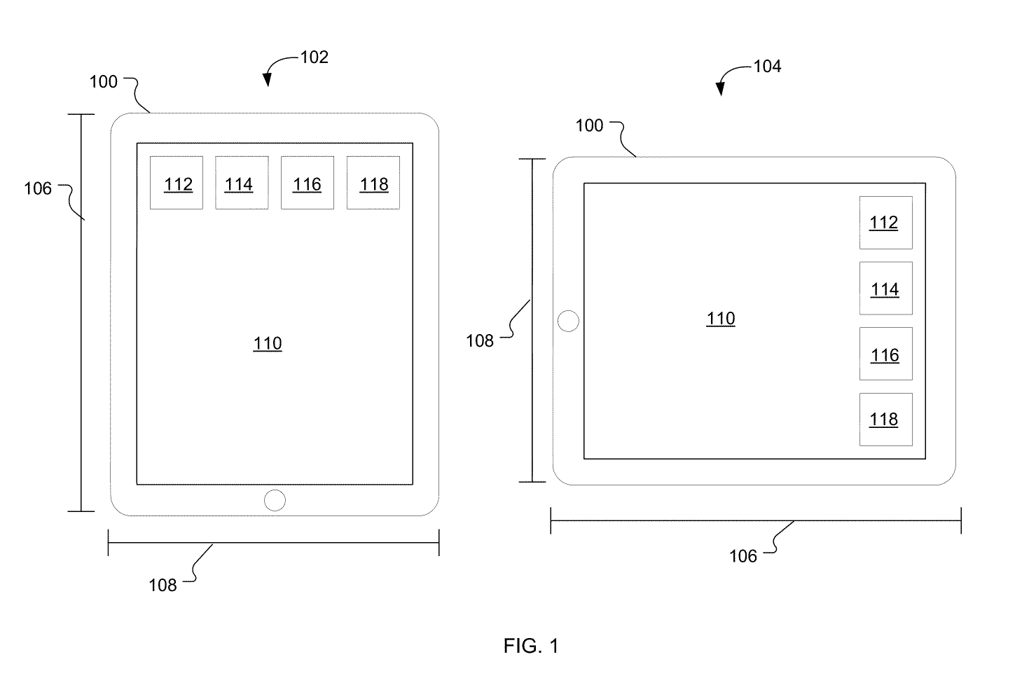

FIG. 1 illustrates a mobile device 100 configured to detect the orientation of the mobile device. For example, mobile device 100 can include one or more motion sensors (e.g., an accelerometer) configured to detect the orientation of the mobile device with respect to the force of gravity. Mobile device 100 can be configured to determine whether the mobile device is currently in a portrait 102 or a landscape 104 orientation based on motion sensor measurements, for example. For example, mobile device 100 can have height 106 (e.g., side 106) that has a length greater than width 108 (e.g., side 108). Portrait orientation 102 can be detected when side 106 of mobile device 100 is in a vertical orientation (e.g., between parallel and perpendicular to the ground) and side 108 is in a horizontal orientation (e.g., about parallel to the ground). Landscape orientation 104 can be detected when side 108 of mobile device 100 is in a vertical orientation (e.g., between parallel and perpendicular to the ground) and side 106 is in a horizontal orientation (e.g., about parallel to the ground).

In some implementations, mobile device 100 can include display 110. For example, display 110 can be a touch sensitive display configured to receive touch input and/or touch gestures such as a tap, swipe, pinch, de-pinch, etc. In some implementations, display 110 can be configured to present one or more graphical objects (e.g., icons) 112, 114, 116 and or 118. In some implementations, graphical objects 112-118 can represent one or more applications configured on mobile device 100. For example, a user can select graphical objects 112-118 to invoke one or more applications on mobile device 100. In some implementations, selection of graphical object 118 can invoke a document creation and editing interface. For example, selection of graphical object 118 can cause a greeting card creation application to be invoked on mobile device 100.

### Document Orientation

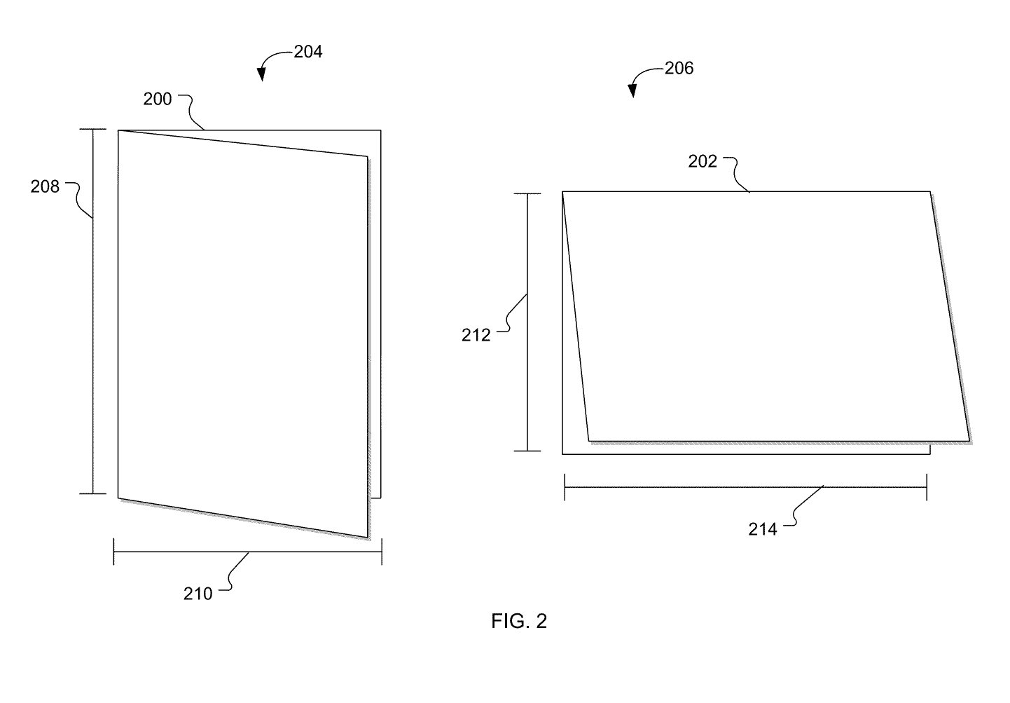

FIG. 2 illustrates document templates 200 and 202 having portrait 204 and landscape 206 orientations, respectively. For example, mobile device 100 can present document templates (e.g., greeting card templates) 200 and 202 in a document creation and editing interface invoked in response to a selection of graphical object 118 of FIG. 1. Document template 200 can have a portrait orientation 204. For example, document template 200 can have a portrait orientation when vertical side 208 (e.g., left edge, right edge) of document template 200 has a length that is greater than the length of horizontal side 210 (e.g., top edge, bottom edge) of document template 200. Document template 202 can have a landscape orientation 206. For example, document template 202 can have a landscape orientation when horizontal side 214 (e.g., top edge, bottom edge) of document template 202 has length that is greater than the length of vertical side 212 (e.g., left edge, right edge) of document template 202.

In some implementations, document templates 200 and 202 and/or additional document templates can be obtained by a mobile device and presented on a display of the mobile device for selection and editing. In some implementations, the mobile device can store a repository of document templates on the mobile device. For example, the mobile device can store on a storage device (e.g., disk drive, solid state drive, flash drive, etc.) a repository or database of document templates. The repository can include metadata for each document template that describes the layout, design, content, images, orientation or other attributes of each document template.

In some implementations, the mobile device can obtain document templates and/or document template information from a server and present representations of the document templates on the mobile device. For example, the document creation and editing application described above can be a client application that provides access to document templates stored on a server. The application can obtain metadata from the server that includes information describing each document template (as described above) and an image of the document template for display on the mobile device. The client application can communicate with the server to allow the user to select and edit a document template to create a finished document (e.g., a greeting card).

### Filtering Documents Based on Device Orientation

In some implementations, document templates can be filtered for display based on the orientation of a mobile device (e.g., mobile device 100 of FIG. 1). For example, the mobile device can be configured to detect and determine the current orientation of the mobile device, as described with reference to FIG. 1, and the mobile device can be configured to present document templates that have orientations that match the orientation of the mobile device. For example, the mobile device can compare the current orientation of the mobile device to document template metadata describing the orientation of the document templates to determine which document templates should be displayed. Thus, when the mobile device is in a landscape orientation, landscape oriented document templates can be displayed. When the mobile device is in a portrait orientation, portrait oriented document templates can be displayed.

### Landscape Oriented Document Interfaces and Animations

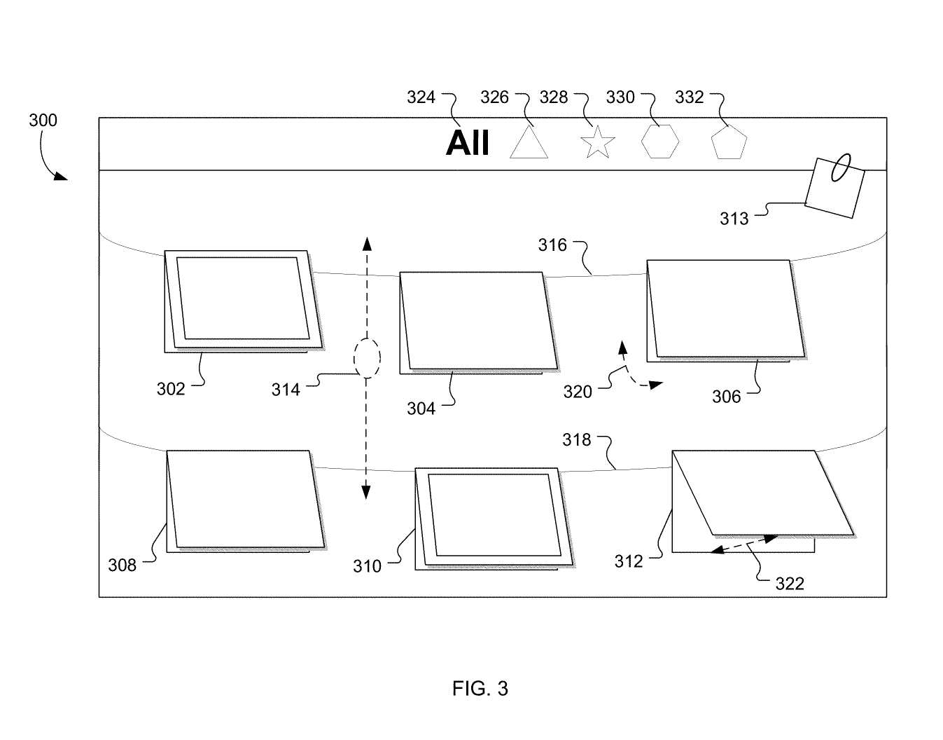

FIG. 3 illustrates a graphical interface 300 for browsing and selecting landscape oriented document templates. For example, graphical interface 300 can be displayed when the mobile device determines that the mobile device is in a landscape orientation. In some implementations, graphical interface 300 can include document templates 302-312. For example, document templates 302-312 can be greeting card templates and each template can have a different design, layout, content, etc. In some implementations, graphical interface 300 can include graphical element 313 for selecting an image to attach to a document template. For example, in response to a selection of graphical element 313, a graphical interface (not shown) displaying images (e.g., photographs, pictures, paintings, drawings, etc.) that can be selected and added to document templates 302-312 can be presented. In some implementations, the displayed images can be filtered based on orientation. For example, images having an orientation (e.g., landscape, portrait) corresponding to the current orientation of the mobile device and/or corresponding to the orientation of the currently displayed document templates can be displayed. Images having an orientation that does not correspond to the current orientation of the mobile device and/or the currently displayed document templates can be hidden. Once the user selects an image, the image can be displayed on the document templates according to the design and layout of each template.

In some implementations, a user can scroll (e.g., scroll up, scroll down) through the available document templates within a document template category (described below) by touch input 314. For example, touch input 314 can be a vertical (e.g., up or down) swipe gesture where the user touches the display of the mobile device with one or more fingers and drags the fingers up or down on the display.

In some implementations, graphical interface 300 can animate document templates 302-312 and other elements of graphical interface 300 when a user scrolls the interface. In some implementations, a clothes line or similar metaphor can be used to present document templates 302-312. For example, graphical interface 300 can include lines 316 and 318. Lines 316 and 318 can have the appearance of rope, wire, thread or cable, for example. Document templates 302-312 can appear to hang on lines 316 and 318. For example, if document templates 302-312 are greeting card templates, then the greeting card templates can appear to straddle and hang from lines 316 and 318. In some implementations, when the user scrolls graphical interface 300, document templates 302-312 can appear to swing or sway on lines 316 and 318. For example, greeting card templates 302-312 can be animated to simulate real-world movement of the greeting cards on lines 316 and 318. Lines 316 and 318 running through the fold in the document templates can act as a fulcrum about which the document templates 302-312 move, swing or sway. For example, each document template 302-312 can have a unique fulcrum or pivot point and can move, swing, or sway independently of the movement of other document templates. Document template 306 can swing 320 in-depth forward to the user and backward away from the user on line 316, for example.

In some implementations, the animation of document templates 302-312 can change based on the direction of the scroll. For example, greeting cards have a folded edge and an open edge. When hanging on lines 316 and 318, the folded edge of the greeting card is at the top and the open edge is at the bottom. When scrolling down (e.g., up swipe), the animation can account for the folded edge deflecting air in the real-world and present a gentle swaying or fluttering animation that causes the greeting cards to appear to sway or flutter. When scrolling up (e.g., down swipe), the animation can account for the open edge catching air in the real-world and provide a billowing or opening animation 322 that causes the greeting cards to appear to catch air and open and close.

In some implementations, lines 316 and 318 can be animated to swing or sway in response to a scroll. For example, lines 316 and 318 can swing as if the ends of lines 316 and 318 (e.g., the left and right ends) were attached to a pin, post or other fixture or fulcrum. Thus, the lines and the document templates can be animated in response to a scroll.

In some implementations, graphical interface 300 can include graphical elements 324-332 for selecting and displaying a category of document templates. For example, a user can select graphical element 324 to cause all document templates to be displayed on graphical interface 300. A user can select one of graphical elements 326-332 to display other document template (e.g., greeting card) categories. For example, selection of a graphical element 326, 328, 330 or 332 can cause holiday templates, seasonal templates, birthday templates or other types or categories of templates to be displayed on graphical interface 300. Thus, the user can filter displayed document templates based on category by selecting one of graphical element 324-332.

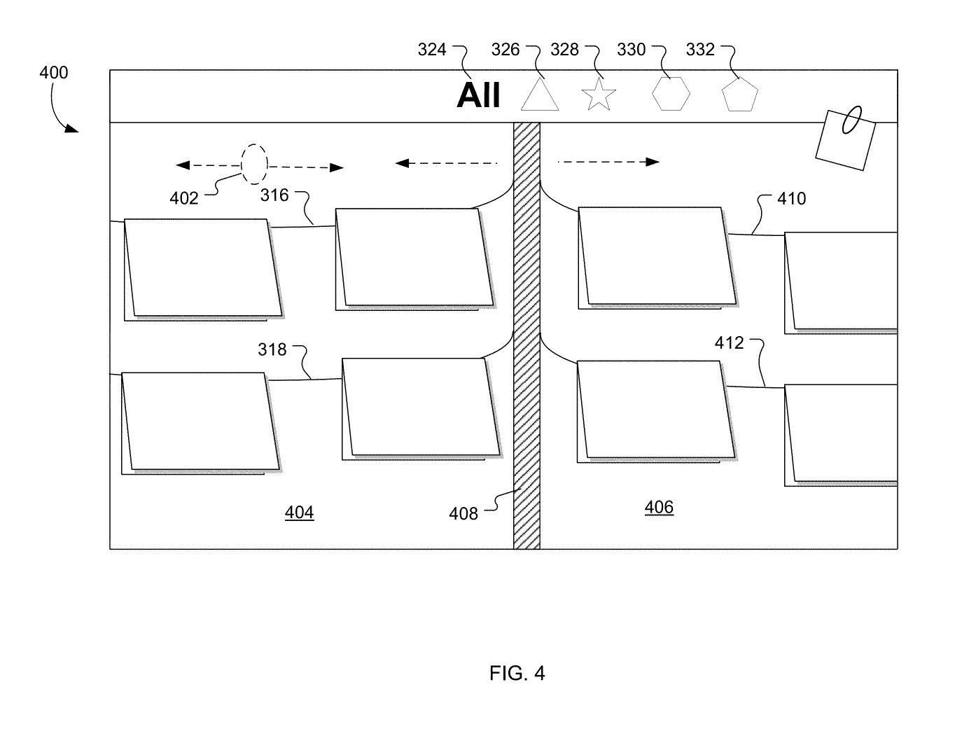

FIG. 4 illustrates a graphical interface 400 for scrolling document template categories. In some implementations, a user can select to display a different document template category by selecting one of graphical elements 324-332. In some implementations, a user can move between document template categories by providing touch input 402 to graphical interface 400. For example, the user can perform a horizontal (e.g., left, right) swipe gesture to move between adjacent categories. If the current category (e.g., birthday category) corresponds to graphical element 328, then a left swipe can cause the category (e.g., holiday category) corresponding to graphical element 330 to be displayed. If the current category (e.g., birthday category) corresponds to graphical element 328, then a right swipe can cause the category (e.g., seasonal category) corresponding to graphical element 326 to be displayed.

In some implementations, document template categories can have different backgrounds. For example, each document template category can display a background 404 and 406 that is different than the backgrounds of other document template categories. For example, document templates of one category can be presented on a background having a flower design with yellow and blue colors. Document templates of another category can be presented on a background having a striped design with purple and white colors. In some implementations, the backgrounds can have the appearance of real-world objects. For example, a background can appear to be a tack board, a textile padded board, wall papered board, a landscape (simulating an outdoor clothes line), etc.

In some implementations, graphical interface 400 can present an animation (e.g., transition) when moving between document template categories. For example, when a category element 324-332 is selected or a user swipes between categories, a scroll animation can be presented on graphical interface 400. The scroll animation can appear to move or slide the current document template category off graphical interface 400 and move or slide the selected document template category into view on graphical interface 400. In some implementations, the document template categories can be delineated by a category divider 408. For example, divider 408 can appear to be a strip of wood, cord, metal or other material separating the document template categories as the user scrolls between categories. In some implementations, divider 408 can appear to have anchor points (e.g., pins, tacks, nails, posts, etc.) to which lines 316, 318, 410 and 412 are attached. As graphical interface 400 scrolls between categories, divider 408 can move across the display (e.g., from left edge to right edge, from right edge to left edge) until divider 408 moves off graphical interface 400 and the selected category of document templates is displayed.

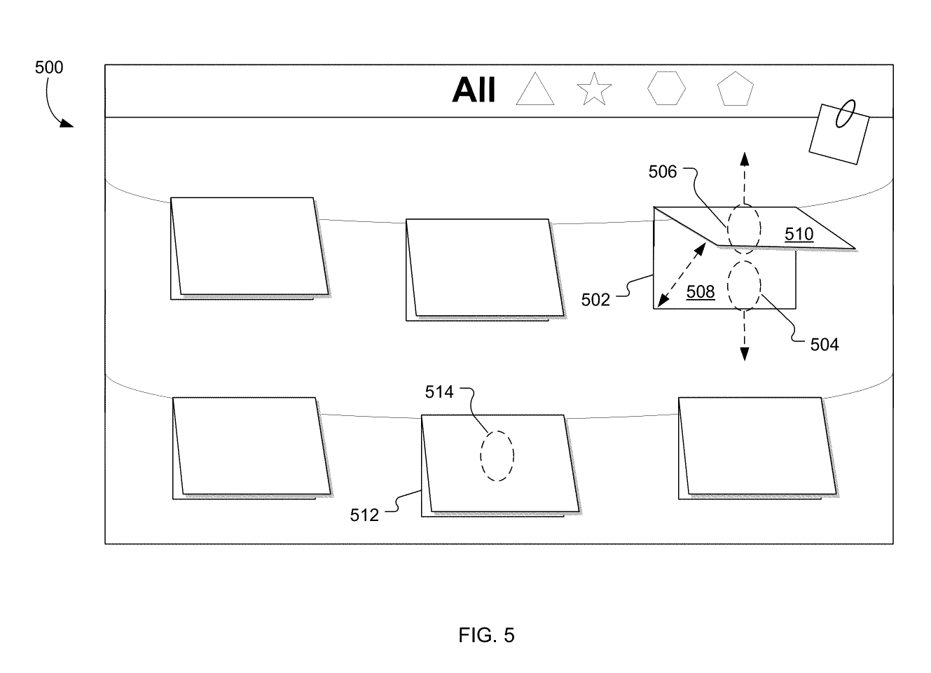

FIG. 5 illustrates a graphical interface 500 for previewing and selecting a document template in landscape orientation. In some implementations, document template 502 can be previewed in response to a de-pinch gesture. For example, a de-pinch gesture is a touch input that uses two fingers. The two fingers 504 and 506 are placed close together on a touch sensitive display and moved apart to perform the de-pinch gesture, as illustrated by the dotted arrows of FIG. 5. The de-pinch gesture can cause graphical interface 500 to present an animation revealing the inside surface of document template 502. For example, if document template 502 is a greeting card, a brochure or other folded document, then document template 502 will have an internal surface 508 and an external surface 510. The internal surface 508 can have content that is hidden when document template 502 is presented on graphical interface 500. To view or preview the internal surface 508, the user can perform a de-pinch gesture (e.g., vertical de-pinch gesture) over document template 502. In response to the de-pinch gesture, document template 502 can be animated to slowly open thereby revealing the content of the inner or internal surface 508. The document template can be closed after the preview in response to a pinch gesture or another input to graphical interface 500.

In some implementations, a user can select a document template to edit by touching or tapping the desired document template on graphical interface 500. For example, a user can select document template 512 by providing touch input 514 (e.g., a tap or touch). In response to receiving touch input 514, the mobile device can display document template 512 in an editing interface so that the user can customize document template 512 according to the user's needs to create a finished document.

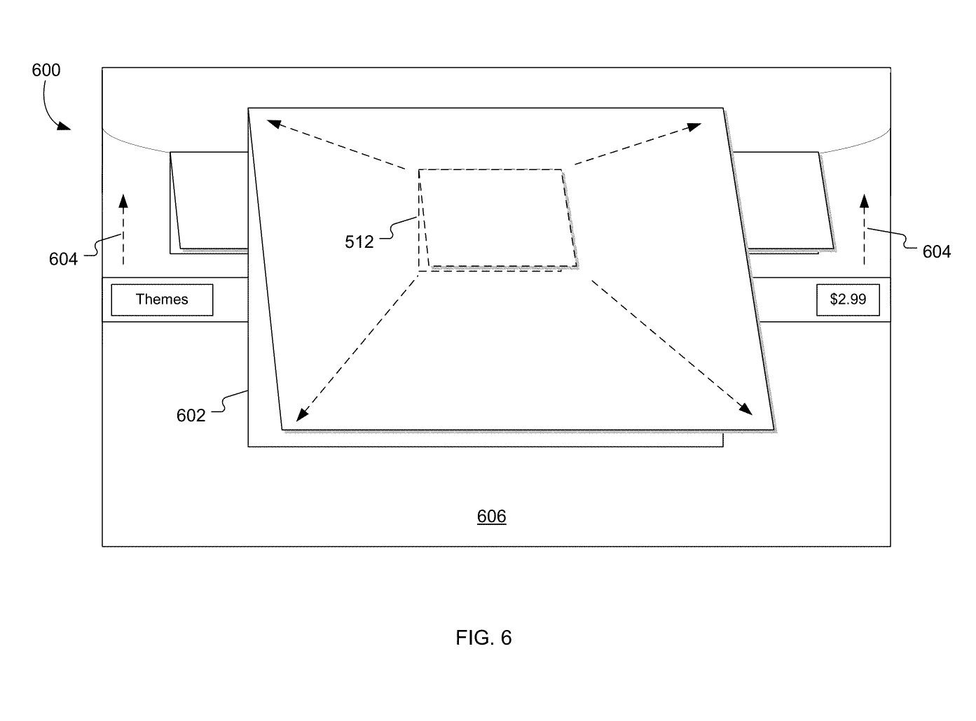

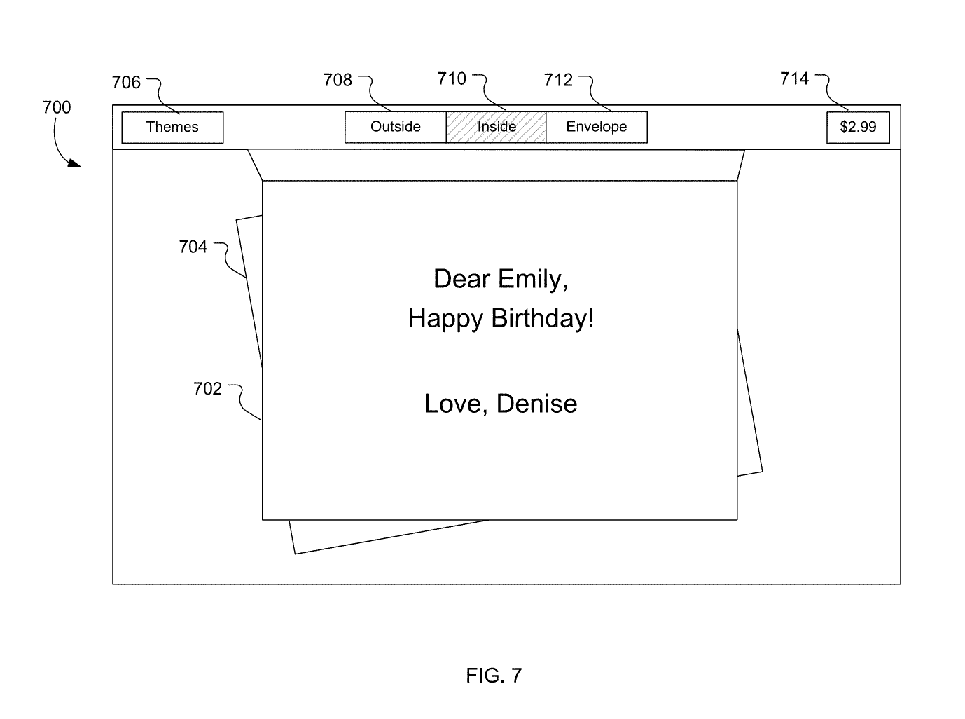

FIG. 6 illustrates an animation 600 for transitioning from the document template selection interface of FIG. 5 to the document template editing interface of FIG. 7. In some implementations, animation 500 can be presented in response to a user selecting a document template (e.g., document template 512) for editing. In some implementations, animation 600 can cause the selected document template to appear to rise above graphical interface 500. For example, document template 512 can be enlarged so that it appears to move closer to the user above graphical interface 500. In some implementations, animation 600 can cause graphical interface 500 to appear slide 604 out from under enlarged document template 602 while a document editing interface 606 slides 604 into view under enlarged document template 602. Once the document editing interface is in place under enlarged document template 602, enlarged document template 602 can be positioned on document editing interface 606 for editing.

FIG. 7 illustrates an example of a landscape oriented document editing interface 700. For example, landscape oriented document editing interface 700 can correspond to document editing interface 606, described above. In some implementations, landscape oriented document editing interface 700 can be displayed in response to a selection of a landscape oriented document template. In some implementations, once a document is selected for customization and/or editing, the orientation of the landscape document editing interface can be locked. For example, when landscape oriented document editing interface 700 is displayed, changes in the mobile device's orientation (e.g., from landscape to portrait) will not cause interface 700 to change.

In some implementations, interface 700 can present document 702 for editing. For example, document 702 can correspond to document template 512 described above. Document 702 can be a greeting card, for example. Document 704 can be an envelope corresponding to greeting card 702, for example. In some implementations, a user can select graphical object 706 to change the theme of greeting card 702. For example, selection of graphical object 706 can cause a graphical interface to be displayed that allows the user to select and change the theme (e.g., design, colors, images, etc.) of greeting card 702.

In some implementations, the user can select graphical element 708 to view the outside of greeting card 702. For example, the user can view the front panel of greeting card 702 by selecting graphical element 708. In some implementations, the user can select graphical element 710 to view the inside of greeting card 702. As illustrated by FIG. 7, graphical element 710 is selected and highlighted and the inside of greeting card 702 is displayed. In some implementations, the user can select graphical element 712 to view envelope 704. In some implementations, a user can select text displayed on greeting card 702 (e.g., on the outside, inside, or envelope) to cause a virtual keyboard (not shown) to be displayed. The virtual keyboard can be used to edit the outside, inside and envelope of greeting card 702.

In some implementations, once the user is done editing greeting card 702, the user can purchase the finished greeting card by selecting graphical element 714. For example, graphical element 714 can indicate the purchase price of the greeting card. Once graphical element 714 is selected and payment information provided, the metadata for the card, including the user's edits, and the payment information can be transmitted to a server and the card can be ordered. In some implementations, an order for a greeting card will cause a real-world paper card to be created according to the user specifications as indicated by the user's selection of a card template and the edits provided by the user.

### Landscape Oriented Document Interfaces and Animations

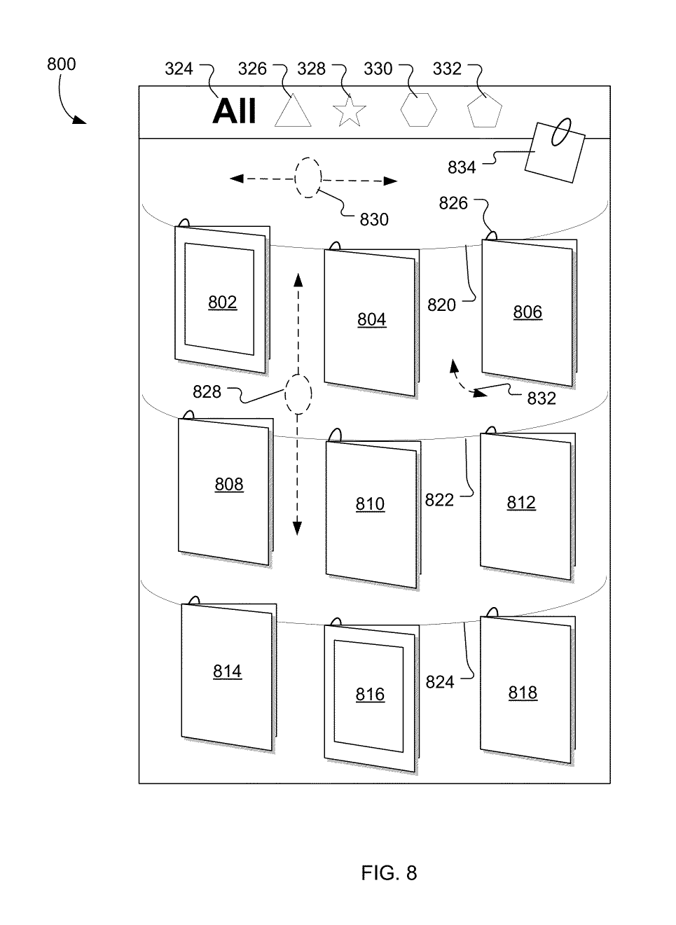

FIG. 8 illustrates an example graphical interface 800 for browsing and selecting portrait oriented document templates. For example, graphical interface 800 can be displayed when the mobile device determines that the mobile device is in a portrait orientation, as described with reference to FIG. 1 above. In some implementations, graphical interface 800 can present document templates 802-818 that have a portrait orientation. For example, document templates 802-818 can have characteristics and metadata that indicate that document templates 802-818 have a portrait orientation, as described with reference to FIG. 2 above.

In some implementations, document templates 802-818 can appear to be hanging from lines 820-824. For example, lines 820-824 can have characteristics similar to lines 316 and 318 of FIG. 3. In some implementations, document templates 802-818 can appear to be clipped to lines 820-824. For example, document 806 appears to be attached to line 820 with clip 826 (e.g., paper clip, clothes pin, etc.).

In some implementations, graphical interface 800 can be scrolled to view additional document templates within a category. For example, a user can provide input in the form of a vertical (e.g., up or down) swipe gesture 828 to scroll document templates within a category, as described above with reference to FIG. 3. In some implementations, graphical interface 800 can be scrolled to view different document template categories. For example, a user can provide input in the form of a horizontal (e.g., left or right) swipe gesture 830 to move between document template categories, as described above with reference to FIG. 4.

In some implementations, an animation can be presented when a user scrolls graphical interface 800. For example, when scrolling within a category and/or between categories, an animation can be presented that causes document templates 802-818 to appear to swing. For example, when graphical interface 800 is scrolled, document template 806 can appear to swing 832 about clip 826. The point at which clip 826 attaches to document template 806 can be the fulcrum of swing 832, for example. For example, each document template 802-818 can have a unique fulcrum or pivot point and can move, swing, or sway independently of the movement of other document templates.

In some implementations, graphical user interface 800 can present a transition animation when moving between categories. For example, when a category graphical element 324-332 is selected or a horizontal swipe gesture 830 is received, graphical user interface 800 can present an animation as described with reference to FIG. 4.

In some implementations, graphical interface 800 can include graphical element 834. For example, graphical element 834 can be selected to attach or add an image to graphical templates 802-818. In some implementations, when mobile device is in portrait orientation, selection of graphical element 834 will cause portrait oriented images to be displayed for selection. For example, selection of graphical element 834 can cause a graphical interface (not shown) to be displayed for selecting images to add to graphical templates 802-818. The image selection interface can be configured to filter out images that do not have an orientation (e.g., landscape, portrait) that matches the current orientation of the mobile device and/or that do not match the orientation of the document templates displayed on graphical interface 800. Once the user selects an image to add to document templates 802-818, the selected image can be displayed on the document templates that are configured to display an image.

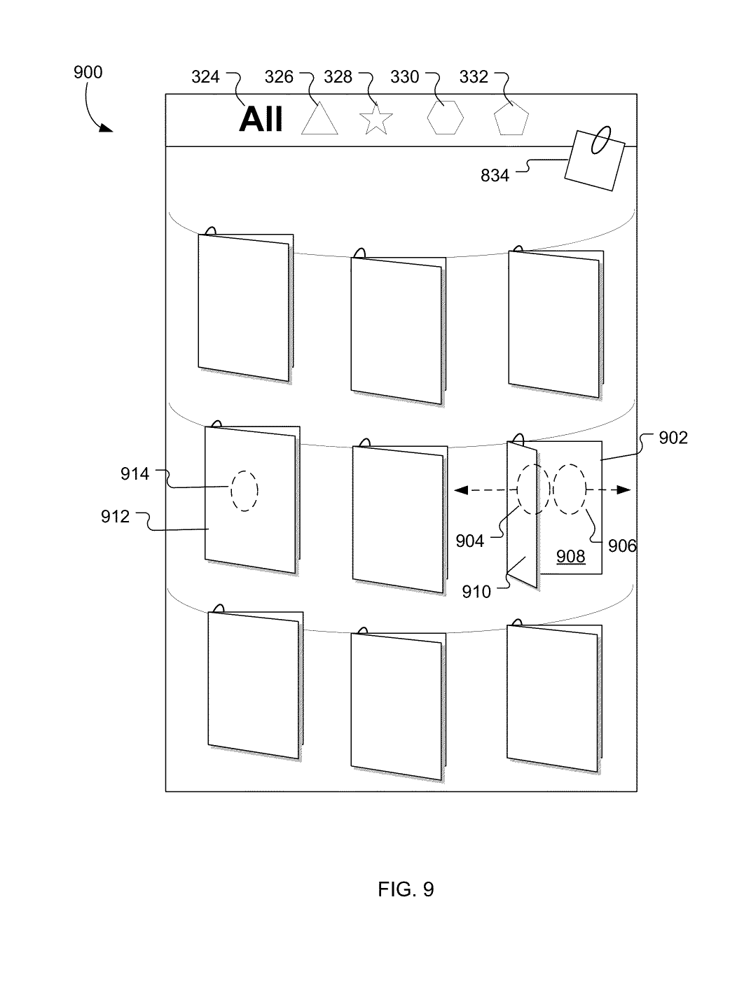

FIG. 9 illustrates a graphical interface 900 for previewing and selecting a document template in portrait orientation. In some implementations, document template 902 can be previewed in response to a de-pinch gesture. For example, a de-pinch gesture is a touch input that uses two fingers. The two fingers 904 and 906 are placed close together on a touch sensitive display and moved apart to perform the de-pinch gesture, as illustrated by the dotted arrows of FIG. 9. The de-pinch gesture can cause graphical interface 900 to present an animation revealing the inside surface of document template 902. For example, if document template 902 is a greeting card, a brochure or other folded document, then document template 902 will have an internal surface 908 and an external surface 910. The internal surface 908 can have content that is hidden when document template 902 is presented on graphical interface 900. To view or preview the internal surface 908, the user can perform a de-pinch gesture (e.g., horizontal de-pinch gesture) over document template 902. In response to the de-pinch gesture, document template 902 can be animated to slowly open thereby revealing the content of the inner or internal surface 908. The document template can be closed after the preview in response to a pinch gesture or another input to graphical interface 900.

In some implementations, a user can select a document template to edit by touching or tapping the desired document template on graphical interface 900. For example, a user can select document template 912 by providing touch input 914 (e.g., a tap or touch). In response to receiving touch input 914, the mobile device can display document template 912 in an editing interface so that the user can customize document template 912 according to the user's needs to create a finished document.

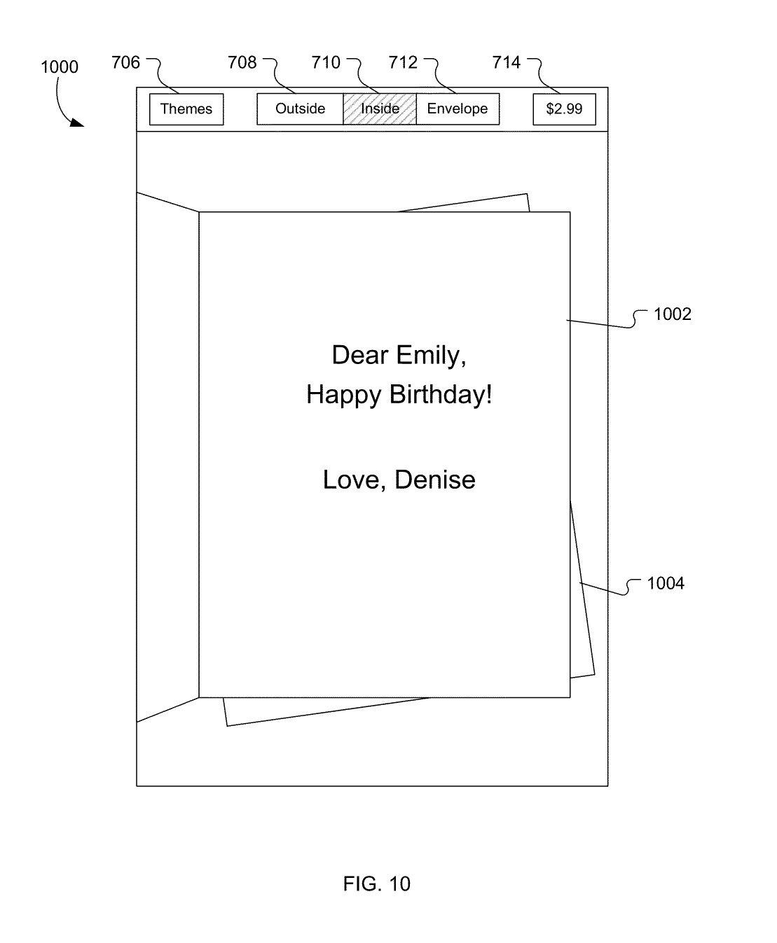

In some implementations, upon receiving a selection of a document template, the mobile device can present an animation for transitioning from the document template selection interface of FIG. 9 to the document template editing interface of FIG. 10. For example, the mobile device can present the animation described with reference to FIG. 8 when transitioning from the document template selection interface 900 to the document editing interface of FIG. 10.

FIG. 10 illustrates an example of a portrait oriented document editing interface 1000. For example, landscape oriented document editing interface 1000 can correspond to document editing interface 606, described above. In some implementations, portrait oriented document editing interface 1000 can be displayed in response to a selection of a portrait oriented document template (e.g., document template 912 of FIG. 9). In some implementations, once a document is selected for customization and/or editing, the orientation of the landscape document editing interface can be locked. For example, when portrait oriented document editing interface 1000 is displayed, changes in the mobile device's orientation (e.g., from landscape to portrait) will not cause interface 1000 to change.

In some implementations, interface 1000 can present document 1002 for editing. For example, document 1002 can correspond to document template 912 described above. Document 1002 can be a greeting card, for example. Document 1004 can be an envelope corresponding to greeting card 1002, for example. In some implementations, a user can select graphical object 706 to change the theme of greeting card 702. For example, selection of graphical object 706 can cause a graphical interface to be displayed that allows the user to select and change the theme (e.g., design, colors, images, etc.) of greeting card 1002.

In some implementations, the user can select graphical element 708 to view the outside of greeting card 1002. For example, the user can view the front panel of greeting card 1002 by selecting graphical element 708. In some implementations, the user can select graphical element 710 to view the inside of greeting card 1002. As illustrated by FIG. 10, graphical element 710 is selected and highlighted and the inside of greeting card 1002 is displayed. In some implementations, the user can select graphical element 712 to view envelope 1004. In some implementations, a user can select text displayed on greeting card 1002 (e.g., on the outside, inside) or envelope 1004 to cause a virtual keyboard (not shown) to be displayed. The virtual keyboard can be used to edit the outside and/or inside of greeting card 1002 and/or envelope 1004.

In some implementations, once the user is done editing greeting card 1002, the user can purchase the finished greeting card by selecting graphical element 714. For example, graphical element 714 can indicate the purchase price of the greeting card. Once graphical element 714 is selected and payment information provided, the metadata for the card, including the user's edits, and the payment information can be transmitted to a server and the card can be ordered. In some implementations, an order for a greeting card will cause a real-world paper card to be created according to the user specifications as indicated by the user's selection of a card template and the edits provided by the user.

### Example Process

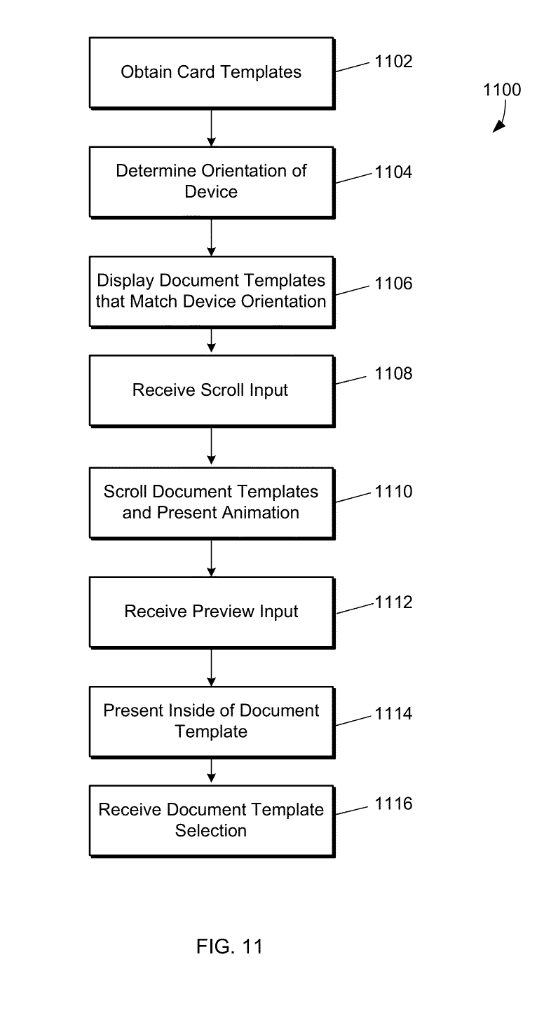

FIG. 11 is flow diagram of an example process 1100 for browsing and selecting document templates. At step 1102, card templates are obtained by a mobile device. For example, the card templates can be obtained from storage on the mobile device or downloaded from a server over a network, as described above with reference to FIG. 2.

At step 1104, the orientation of the mobile device can be determined. For example, motion sensors (e.g., accelerometer, gyroscope, etc.) coupled to the mobile device can detect movement and/or orientation of the mobile device. The motion sensors can determine a direction with respect to the force of gravity and determine the mobile device's orientation (e.g., landscape, portrait, etc.) based on how the force of gravity is affecting the motion sensors on the mobile device.

At step 1106, the mobile device can display document templates that match the mobile device's orientation. For example, if the mobile device is currently in a portrait orientation, the mobile device can filter out document templates from the document templates obtained at step 1102 that are not in a portrait orientation and display those document templates that have a portrait orientation. If the mobile device is currently in a landscape orientation, the mobile device can filter out document templates from the document templates obtained at step 1102 that are not in a landscape orientation and display those document templates that have a landscape orientation. Once the document templates have been filtered based on orientation, representations of the document templates (e.g., thumbnail images) can be presented for each document template matching the orientation of the mobile device.

At step 1108, the mobile device can receive input to scroll the display of document templates. For example, the user can provide a swipe input to scroll through the displayed document templates in a selected category or to scroll between categories of document templates, as described above.

At step 1110, the document templates can be scrolled and a document template animation presented that simulates movement of the document templates. For example, when the document templates are scrolled, the displayed document templates can be animated to appear to swing, sway, flutter, billow, open or otherwise move in response to the scrolling movement, as described above with reference to FIG. 3 and FIG. 8.

At step 1112, document template preview input can be received at the mobile device. For example, the document template preview input can be a touch input (e.g., tap) or a gesture (e.g., de-pinch, swipe, etc.) associated with the displayed document template. At step 1114, the document template preview input can invoke a preview of the inside of the document template (e.g., inside of a greeting card), as described with reference to FIG. 5 and FIG. 9.

At step 1116, a document template selection can be received. For example, the user can select a document template and a document having the same characteristics or attributes of the selected document template can be generated. The user can edit the generated document to customize the document to suit the user's needs. In some implementations, in response to the selection of the card template, an animation can be presented for transitioning from a document template selection interface to a document editing interface, as described above with reference to FIG. 6.

### Example System Architecture

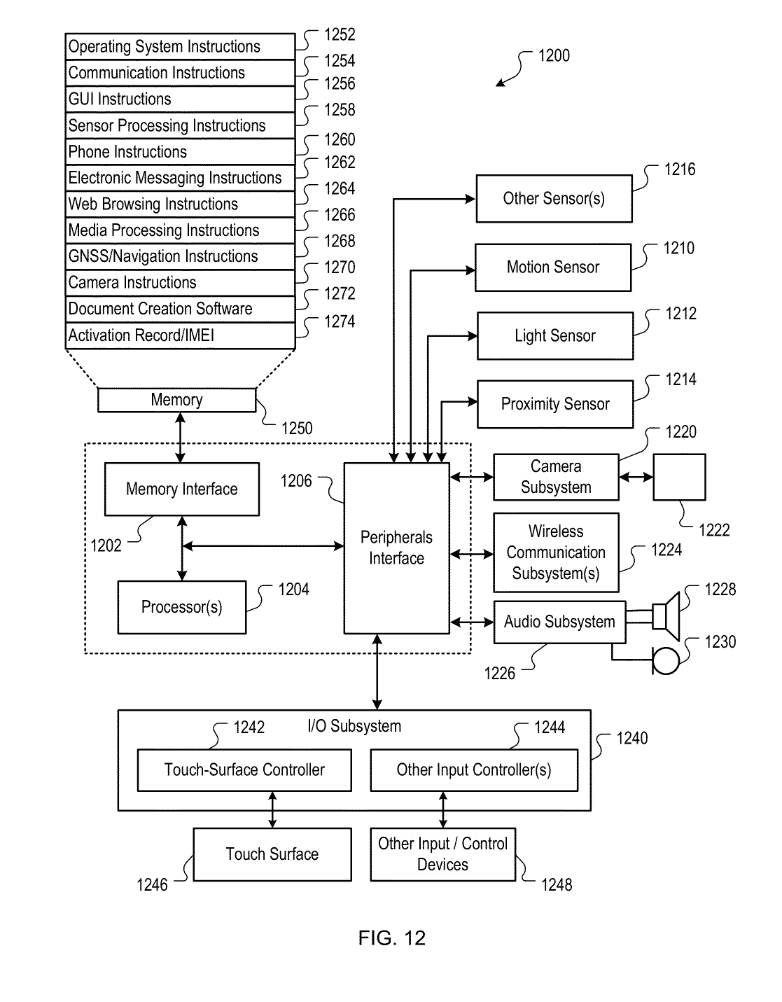

FIG. 12 is a block diagram of an example computing device 1200 that can implement the features and processes of FIGS. 1-11. The computing device 1200 can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the computing device 1200 can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate orientation, lighting, and proximity functions. Other sensors 1216 can also be connected to the peripherals interface 1206, such as a global navigation satellite system (GNSS) (e.g., GPS receiver), a temperature sensor, a biometric sensor, or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips. The camera subsystem 1220 and the optical sensor 1222 can be used to collect images of a user to be used during authentication of a user, e.g., by performing facial recognition analysis.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the computing device 1200 is intended to operate. For example, the computing device 1200 can include communication subsystems 1224 designed to operate over a GSM network, a GPRS network, an EDGE network, a Wi-Fi or WiMax network, and a Bluetooth™ network. In particular, the wireless communication subsystems 1224 can include hosting protocols such that the device 100 can be configured as a base station for other wireless devices.

An audio subsystem 1226 can be coupled to a speaker 1228 and a microphone 1230 to facilitate voice-enabled functions, such as speaker recognition, voice replication, digital recording, and telephony functions. The audio subsystem 1226 can be configured to facilitate processing voice commands and voice authentication, for example.

The I/O subsystem 1240 can include a touch-surface controller 1242 and/or other input controller(s) 1244. The touch-surface controller 1242 can be coupled to a touch surface 1246. The touch surface 1246 and touch-surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration can disengage a lock of the touch surface 1246; and a pressing of the button for a second duration that is longer than the first duration can turn power to the computing device 1200 on or off. Pressing the button for a third duration can activate a voice control, or voice command, module that enables the user to speak commands into the microphone 1230 to cause the device to execute the spoken command. The user can customize a functionality of one or more of the buttons. The touch surface 1246 can, for example, also be used to implement virtual or soft buttons and/or a keyboard.

In some implementations, the computing device 1200 can present recorded audio and/or video files, such as MP3, AAC, and MPEG files. In some implementations, the computing device 1200 can include the functionality of an MP3 player, such as an iPod™. The computing device 1200 can, therefore, include a 36-pin connector that is compatible with the iPod. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks.

The operating system 1252 can include instructions for handling basic system services and for performing hardware dependent tasks. In some implementations, the operating system 1252 can be a kernel (e.g., UNIX kernel). In some implementations, the operating system 1252 can include instructions for performing voice authentication. For example, operating system 1252 can implement one or more of the features described with reference to FIGS. 1-11.

The memory 1250 can also store communication instructions 1254 to facilitate communicating with one or more additional devices, one or more computers and/or one or more servers. The memory 1250 can include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GNSS/Navigation instructions 1268 to facilitate GNSS and navigation-related processes and instructions; and/or camera instructions 1270 to facilitate camera-related processes and functions.

The memory 1250 can store other software instructions 1272 to facilitate other processes and functions, such as the document creation, filtering and animation processes and functions as described with reference to FIGS. 1-11. For example, the software instructions can include instructions for filtering documents based on the orientation of device 100.

The memory 1250 can also store other software instructions (not shown), such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively. An activation record and International Mobile Equipment Identity (IMEI) 1274 or similar hardware identifier can also be stored in memory 1250.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the computing device 1200 can be implemented in hardware and/or in software, including in one or more signal processing and/or application specific integrated circuits.

What is claimed is:

1. A method comprising:
obtaining a plurality of document templates on a mobile device, where each of the document templates has one of a plurality of orientations;
determining a current orientation of the mobile device;
determining which of the document templates have orientations that match the current orientation of the mobile device; and
displaying the matching document templates.

2. The method of claim 1, wherein the plurality of document templates are greeting card templates.

3. The method of claim 1, wherein the plurality of orientations include landscape and portrait orientations.

4. The method of claim 1, wherein determining the current orientation of the mobile device includes receiving accelerometer measurements.

5. The method of claim 1, further comprising:
detecting that the current orientation of the mobile device has changed from a first orientation to a second orientation;
determining which of the document templates have orientations that match the second orientation; and
displaying the document templates that match the second orientation.

6. The method of claim 1, further comprising:
receiving a scroll input at the mobile device;
scrolling the displayed document templates; and
presenting an animation that causes the displayed document templates to appear to move about a fulcrum.

7. The method of claim 1, wherein the displayed document templates include a folded document template having a hidden inside surface and a visible outside surface and further comprising:
receiving a de-pinch gesture associated with the folded document template; and
in response to the de-pinch gesture, presenting the inside surface of the folded document template.

8. A method comprising:
displaying a background on a graphical interface of a mobile device;
displaying a plurality of lines over the background of the graphical interface, the lines running horizontally across the graphical interface; and
displaying a plurality of document templates on the graphical interface, where the document templates appear to be hanging from the lines.

9. The method of claim 8, further comprising:
receiving input to scroll the graphical interface;
scrolling the graphical interface; and
in response to the scrolling, animating the document templates to appear to swing on the lines.

10. The method of claim 9, wherein each of the document templates swings about a separate fulcrum.

11. The method of claim 8, further comprising:
receiving input to scroll the graphical interface;
scrolling the graphical interface; and
in response to the scrolling, animating the lines to appear to swing about attachments at the ends of the lines.

12. The method of claim 8, wherein the lines appear to be strings, rope, or cable.

13. The method of claim 8, wherein the document templates represent folded documents and the folded documents appear to straddle the lines at a fold in the documents.

14. The method of claim 8, wherein the document templates appear to be clipped to the lines.

15. A non-transitory computer-readable medium including one or more sequences of instructions which, when executed by one or more processors, causes:
obtaining a plurality of document templates on a mobile device, where each of the document templates has one of a plurality of orientations;
determining a current orientation of the mobile device;
determining which of the document templates have orientations that match the current orientation of the mobile device; and
displaying the matching document templates.

16. The non-transitory computer-readable medium of claim 15, wherein the plurality of document templates are greeting card templates.

17. The non-transitory computer-readable medium of claim 15, wherein the plurality of orientations include landscape and portrait orientations.

18. The non-transitory computer-readable medium of claim 15, wherein determining the current orientation of the mobile device includes receiving accelerometer measurements.

19. The non-transitory computer-readable medium of claim 15, wherein the instructions cause:
detecting that the current orientation of the mobile device has changed from a first orientation to a second orientation;
determining which of the document templates have orientations that match the second orientation; and
displaying the document templates that match the second orientation.

20. The non-transitory computer-readable medium of claim 15, wherein the instructions cause:
receiving a scroll input at the mobile device;
scrolling the displayed document templates; and
presenting an animation that causes the displayed document templates to appear to move about a fulcrum.

21. The non-transitory computer-readable medium of claim 15, wherein the displayed document templates include a folded document template having a hidden inside surface and a visible outside surface and wherein the instructions cause:
receiving a de-pinch gesture associated with the folded document template; and
in response to the de-pinch gesture, presenting the inside surface of the folded document template.

22. A non-transitory computer-readable medium including one or more sequences of instructions which, when executed by one or more processors, causes:
displaying a background on a graphical interface of a mobile device;
displaying a plurality of lines over the background of the graphical interface, the lines running horizontally across the graphical interface; and
displaying a plurality of document templates on the graphical interface, where the document templates appear to be hanging from the lines.

23. The non-transitory computer-readable medium of claim 22, wherein the instructions cause:
receiving input to scroll the graphical interface;
scrolling the graphical interface; and
in response to the scrolling, animating the document templates to appear to swing on the lines.

24. The non-transitory computer-readable medium of claim 23, wherein each of the document templates swings about a separate fulcrum.

25. The non-transitory computer-readable medium of claim 22, wherein the instructions cause:
receiving input to scroll the graphical interface;
scrolling the graphical interface; and
in response to the scrolling, animating the lines to appear to swing about attachments at the ends of the lines.

26. The non-transitory computer-readable medium of claim 22, wherein the lines appear to be strings, rope, or cable.

27. The non-transitory computer-readable medium of claim 22, wherein the document templates represent folded documents and the folded documents appear to straddle the lines at a fold in the documents.

28. The non-transitory computer-readable medium of claim 22, wherein the document templates appear to be clipped to the lines.

29. A system comprising:
one or more processors; and
a non-transitory computer-readable medium including one or more sequences of instructions which, when executed by the one or more processors, causes:
obtaining a plurality of document templates on a mobile device, where each of the document templates has one of a plurality of orientations;
determining a current orientation of the mobile device;
determining which of the document templates have orientations that match the current orientation of the mobile device; and
displaying the matching document templates.

30. The system of claim 29, wherein the plurality of document templates are greeting card templates.

31. The system of claim 29, wherein the plurality of orientations include landscape and portrait orientations.

32. The system of claim 29, wherein determining the current orientation of the mobile device includes receiving accelerometer measurements.

33. The system of claim 29, wherein the instructions cause:
detecting that the current orientation of the mobile device has changed from a first orientation to a second orientation;
determining which of the document templates have orientations that match the second orientation; and
displaying the document templates that match the second orientation.

34. The system of claim 29, wherein the instructions cause:
receiving a scroll input at the mobile device;
scrolling the displayed document templates; and
presenting an animation that causes the displayed document templates to appear to move about a fulcrum.

35. The system of claim 29, wherein the displayed document templates include a folded document template having a hidden inside surface and a visible outside surface and wherein the instructions cause:
receiving a de-pinch gesture associated with the folded document template; and
in response to the de-pinch gesture, presenting the inside surface of the folded document template.

36. A system comprising:
one or more processors; and
a non-transitory computer-readable medium including one or more sequences of instructions which, when executed by the one or more processors, causes:
displaying a background on a graphical interface of a mobile device;
displaying a plurality of lines over the background of the graphical interface, the lines running horizontally across the graphical interface; and
displaying a plurality of document templates on the graphical interface, where the document templates appear to be hanging from the lines.

37. The system of claim 36, wherein the instructions cause:
receiving input to scroll the graphical interface;
scrolling the graphical interface; and
in response to the scrolling, animating the document templates to appear to swing on the lines.

38. The system of claim 37, wherein each of the document templates swings about a separate fulcrum.

39. The system of claim 36, wherein the instructions cause:
receiving input to scroll the graphical interface;
scrolling the graphical interface; and
in response to the scrolling, animating the lines to appear to swing about attachments at the ends of the lines.

40. The system of claim 36, wherein the lines appear to be strings, rope, or cable.

41. The system of claim 36, wherein the document templates represent folded documents and the folded documents appear to straddle the lines at a fold in the documents.

42. The system of claim 36, wherein the document templates appear to be clipped to the lines.
